(19) United States
(12) Patent Application Publication
(10) Pub. No.: US 2008/0178200 A1
(43) Pub. Date: Jul. 24, 2008

(54) METHOD FOR ALLOCATING PERIPHERAL DEVICE, INFORMATION PROCESSING SYSTEM, INFORMATION PROCESSING UNIT AND MANAGEMENT APPARATUS

(76) Inventors: Shinobu KANEKO, Kuki (JP); Teppei Ogawa, Tokyo (JP); Koji Takahashi, Ichikawa (JP); Koji Kikuchi, Ichikawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/858,161

(22) Filed: Sep. 20, 2007

(30) Foreign Application Priority Data
Nov. 15, 2006 (JP) 2006-308542

(51) Int. Cl. G06F 9/54

(52) U.S. Cl. 719/321

(57) ABSTRACT

A management apparatus including a storing portion for storing information relating to utilization sites of a plurality of terminals and driver with information of the plurality of peripheral devices in association with one another, and a control portion for specifying any of the peripheral devices from among the plurality of peripheral devices on the basis of the information regarding the utilization site of the terminal and the information of the storage means, and reading out the driver and driver setting information of the peripheral device specified from the storage portion and transmitting the driver and driver setting information to an information processing unit communicating with the terminal. The information processing unit includes a reception portion for receiving the driver and driver setting information of the peripheral device and a processing portion for executing installation of the driver received by the reception portion and setting of the driver setting information.

### INCORPORATION BY REFERENCE

The present application claims priority from Japanese application JP2006-308542 filed on Nov. 15, 2006, the content of which is hereby incorporated by reference into this application.

### BACKGROUND OF THE INVENTION

This invention relates to an information processing system including a management apparatus, a plurality of information processing units, terminals and peripheral devices that are connected to one another through a network. More particularly, the invention relates to a technology for allocating the peripheral devices in this information processing system.

Demands have been increasing in recent years for a style (free address work style) that prepares shared seats without allocating fixed sheets to individuals and allows each employee coming to an office to use an empty seat.

A so-called “thin client type” information processing system has also drawn an increasing attention in recent years. In the thin client type information processing system, a desktop such as a blade PC (Personal Computer) installed in a server room or an information center is remotely operated by using a terminal available at hand and various application programs installed to the blade PC and data can thus be utilized. The possibility of information leak owing to theft of the terminal, etc, can be reduced by using a so-called “HDD (Hard Disk Driver)-less type” PC for the terminal (refer to JP-A-2003-337672, for example).

When a user uses a peripheral device such as a printer or a scanner in such a thin client type information processing system, it has been customary in the past for the user to manually install a driver or to manually set driver setting information, and this operation is troublesome and time consuming. To solve this problem, a technology is known that automatically installs a driver of a printer selected by the user from a printer list displayed on a display portion of the terminal and executes various kinds of setting (refer to JP-A-2006-134245, for example).

### SUMMARY OF THE INVENTION

A technology has been required in the thin client type information processing unit that automatically allocates a peripheral device suitable for a utilization site of a terminal to the terminal and automatically installs a driver of the peripheral device allocated and automatically sets driver setting information.

In view of the problems described above, it is an object of the invention to provide a technology for automatically allocating a peripheral device suitable for a utilization site of a peripheral device to the peripheral device and automatically executing installation of a peripheral device driver allocated and setting of driver setting information.

To accomplish the object described above, the invention provides an information processing system including a management apparatus, a plurality of terminals, a plurality of information processing units and a plurality of peripheral devices that are connected to one another through a network, wherein the terminal has means for transmitting address information of an information processing unit as a communication counter-part and information relating to a utilization site of the terminal to the management apparatus through the network; the management apparatus includes means for storing information relating to utilization sites of the plurality of terminals and driver and driver setting information of the plurality of peripheral devices in association with one another, means for receiving from the terminal the address information of the information processing unit and the information relating to the utilization site of the terminal through the network, means for specifying any of the peripheral devices from among the plurality of peripheral devices on the basis of the information relating to the utilization site of the terminal received by the reception means and the information of storage means, and means for reading out the driver and driver setting information of the peripheral device specified from the storage means and transmitting the driver and driver setting information to the information processing unit through the network on the basis of the address information; and the information processing unit includes means for receiving the driver and driver setting information of the peripheral device from the management apparatus through the network and means for executing installation of the driver received and setting of the driver setting information.

To accomplish the object described above, the invention further provides an information processing unit connected to at least a plurality of terminals and a plurality of peripheral devices through a network, including a storage portion for storing information relating to utilization sites of the plurality of terminals in association with driver and driver setting information of the plurality of peripheral devices; and a control portion for generating a screen for inputting the information relating to the utilization site of the terminal when an output instruction of an application is received from the terminal, transmitting the screen to the terminal, specifying any of the peripheral devices from the plurality of peripheral devices on the basis of the information relating to the utilization sites of the terminals received and the information of the storage portion when the information relating to the utilization site of the terminal is received from the terminal, generating the output data on the basis of the driver and driver setting information of the peripheral device and the application, and transmitting the data to the peripheral device through the network.

### BRIEF DESCRIPTION OF THE DRAWINGS

FIG. 1 shows an example of a schematic construction of an information processing system according to one embodiment of the invention.

FIG. 2 shows a schematic structural example of a management apparatus 5 in the first embodiment of the invention.

FIG. 3 shows a structural example of an authentication information management table 244 in the first embodiment of the invention.

FIG. 4 shows a structural example of a peripheral device allocation table 245 in the first embodiment of the invention.

FIG. 5 shows a structural example of a driver and driver setting information management table 245 in the first embodiment of the invention.

FIG. 6 shows a schematic structural example of an information processing unit 6 in the first embodiment of the invention.

FIG. 7 shows a schematic structural example of a terminal 1 in the first embodiment of the invention.

FIG. 8 shows a schematic structural example of an authentication device 2 in the first embodiment of the invention.

FIG. 9 is a view for explaining operations of the entire information processing system in the first embodiment of the invention.

FIG. 10 is also a view for explaining the operations of the entire information processing system in the first embodiment of the invention.

FIG. 11 is a view for explaining an allocation method of seat information in the first embodiment of the invention.

FIG. 12 shows an example of an information list of the information processing unit and a seat information input form in the first embodiment of the invention.

FIG. 13 shows an example of a display screen for reporting an allocated peripheral device to a user in the first embodiment of the invention.

FIG. 14 shows a schematic structural example of an information processing unit 6 in the second embodiment of the invention.

FIG. 15 is a view for explaining operations of an entire information processing system in the second embodiment of the invention.

FIG. 16 is also a view for explaining the operations of the entire information processing system in the second embodiment of the invention.

FIG. 17 shows an example of a display screen for reporting a peripheral device of a printing destination to a user in the second embodiment of the invention.

FIG. 18 shows a structural example of a peripheral device condition management table 247 in a third embodiment of the invention.

### DESCRIPTION OF THE EMBODIMENTS

### First Embodiment

The first embodiment of the invention will be hereinafter explained.

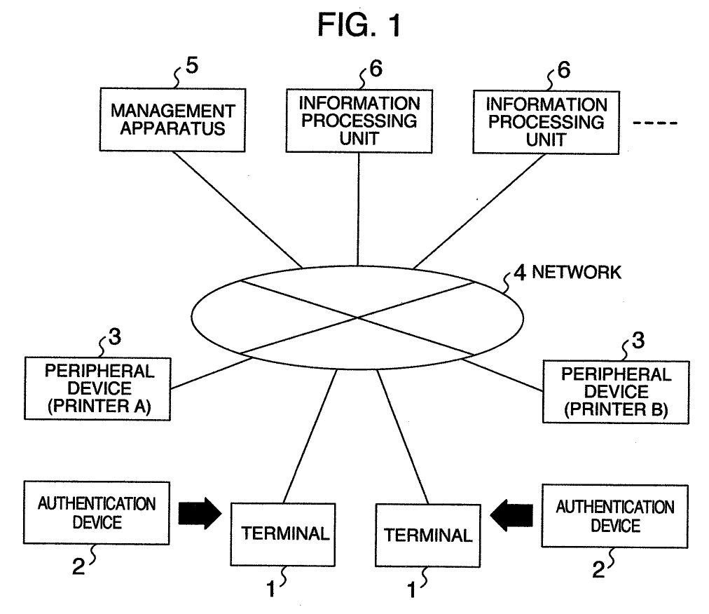

FIG. 1 is a view showing an example of a schematic construction of an information processing system according to the first embodiment of the invention.

As shown in the drawing, the information processing system of this embodiment includes a plurality of terminals 1, a plurality of authentication devices 2, a plurality of peripheral devices 3, a management apparatus 5 and a plurality of information processing units 6. The terminal 1, the peripheral device 3, the management apparatus 5 and the information processing unit 6 are connected to a network 4 such as an LAN (Local Area Network). The authentication device 2 can be connected and removed to and from the terminal 1.

The management apparatus 5 has the function of authenticating a user, the function of judging which of the peripheral devices is suitable for the utilization site of the terminal 1 among a plurality of peripheral devices 3 and transmitting a peripheral device driver and driver setting information to the information processing unit 6 that remotely communicates with the terminal 1, the function of managing the information processing units 6, and so forth. A server apparatus, or the like, is employed for the management apparatus 5.

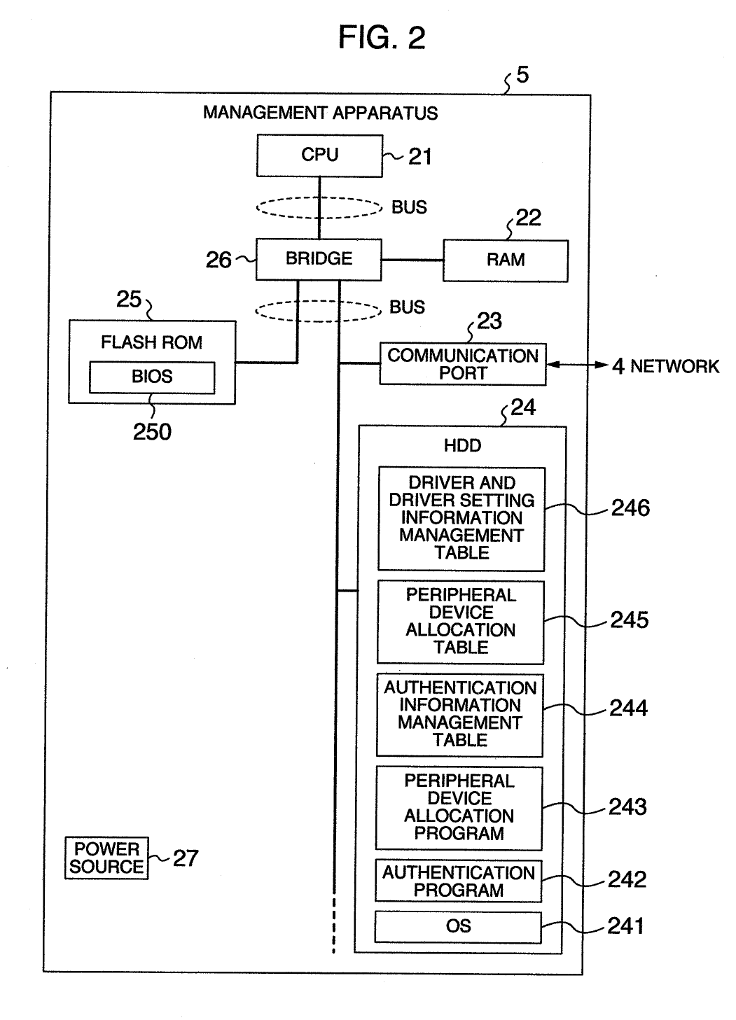

FIG. 2 shows a schematic structural example of the management apparatus 5.

As shown in the drawing, the management apparatus 5 includes a CPU (Central Processing Unit) 21, an RAM (Random Access Memory) 22 operating as a work area of the CPU 21, a communication port 23 executing transmission and reception of information to and from the network 4, an HDD (Hard Disk Drive) 24, a flash ROM (Read Only Memory) 25, a bridge 26 for relaying internal connection lines such as a bus BUS for connecting each of these constituents 21 to 25, and a power source 27.

The flash ROM 25 stores BIOS (Basic Input/Output System) 250. After the power source 27 is turned on, the CPU 21 first gains access to the flash ROM 25, executes the BIOS 250 and recognizes the system construction of the management apparatus 5.

The HDD 24 stores at least an OS (Operating System) 241, an authentication program 242, a peripheral device allocation program 243, an authentication information management table 244, a peripheral device allocation table 245 and a driver and driver setting information management table 246.

The OS 241 is a program by which the CPU 21 collectively controls each part 22 to 27 of the management apparatus 5 and executes the authentication program 242 and the peripheral device allocation program 243 as will be later described. The CPU 21 loads the OS 241 from the HDD 24 to the RAM 22 and executes the OS 241 in accordance with the BIOS 250. In consequence, the CPU 21 collectively controls each part 22 to 27 of the management apparatus 5.

The authentication program 242 has the function of authenticating the user from the remote authentication information from the terminal 1 and the information stored in the authentication information management table 244. The CPU 21 loads the authentication program 242 from the HDD 24 and executes it in accordance with the OS 241.

The peripheral device allocation program 243 has the function of allocating a peripheral device suitable for a utilization site to a terminal on the basis of seat information from the terminal 1, information stored in the peripheral device allocation table 245 and information stored in the driver and driver setting information management table 246, and transmitting the allocated peripheral device driver and driver setting information to the information processing unit 6 that execute remote communication with the terminal 1. The CPU 21 loads the peripheral device allocation program 243 from the HDD 24 and executes it in accordance with the OS 241.

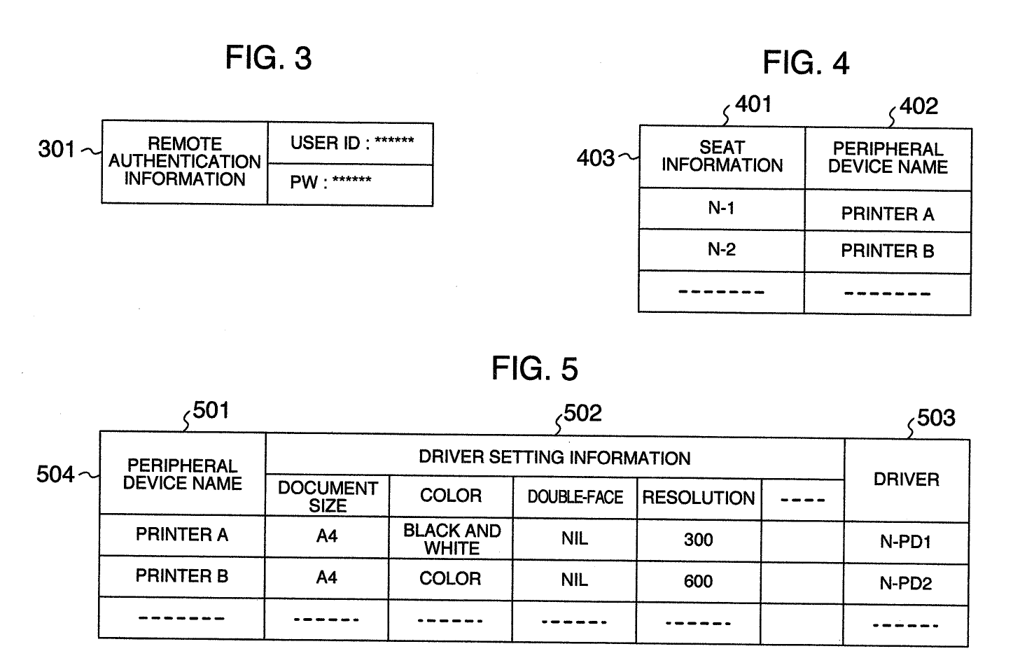

Remote authentication information (user ID, password) 301 for the authentication program 242 to authenticate the user of the terminal 1 as a terminal service provision counter-part of the information processing unit 6 is registered to the authentication information management table 244 as shown in FIG. 3.

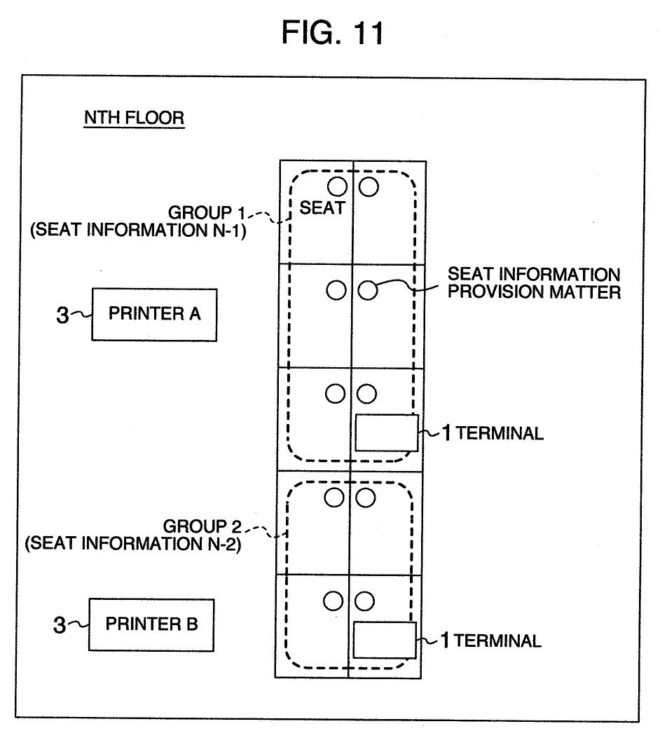

The name of the peripheral device associated with seat information is so stored as to correspond to the seat information in the peripheral device allocation table 245. In this embodiment, the seat information (information associated with the utilization site of the terminal 1) is provided for each seat at which work is executed by the user by using the terminal 1 as shown in FIG. 11. Here, those seats at which the peripheral device closest to the utilization site of the terminal 1 is the same are grouped into one group and the same seat information is allocated to such a group. For example, the group using a printer A is called “group 1” (group identification information) and the seat information N−1 corresponding to this group 1 is allocated to the seats belonging to the group 1. FIG. 4 shows a structural example of the peripheral device allocation table 245. The peripheral device allocation table 245 includes a plurality of records 403 as shown in the drawing. The record 403 has a field 401 for registering the seat information and a field 402 for registering the peripheral device name.

A driver of a peripheral device that is associated with the peripheral device name and the driver setting information are stored for each peripheral device name in the driver and driver setting information management table 245. FIG. 5 shows a structural example of the driver and driver setting information management table 246. The driver and driver setting information management table 246 has a plurality of records 504 as shown in the drawing. The record 504 includes a field 501 for registering the peripheral device name, a field 502 for registering the driver setting information and a field 503 for registering the driver. The driver is a program for controlling the printer and other output devices or input devices. The number of registration of the drivers and driver setting information are changeable. In this case, the management apparatus 5 may be provided with the function of managing the registration date of the driver and its history information such as the use time and deleting serially the obsolete driver and driver setting information by looking up the history information when the number of registration of the drivers and driver setting information exceeds a maximum number of registration or the function of deleting the driver and driver setting information when they are not used for a predetermined period of time. In this way, it is possible to prevent the driver and driver setting information from being unlimitedly built up in the HDD 24.

The explanation will be continued by turning back again to FIG. 1.

The information processing unit 6 provides a terminal service to the terminal 1. In other words, the information processing unit 6 receives and processes the input information (operation content of keyboard and mouse) sent from the terminal 1 and transmits information representing the processing result (desktop screen of display) to the terminal 1. A blade PC, or the like, is used for this information processing unit 6.

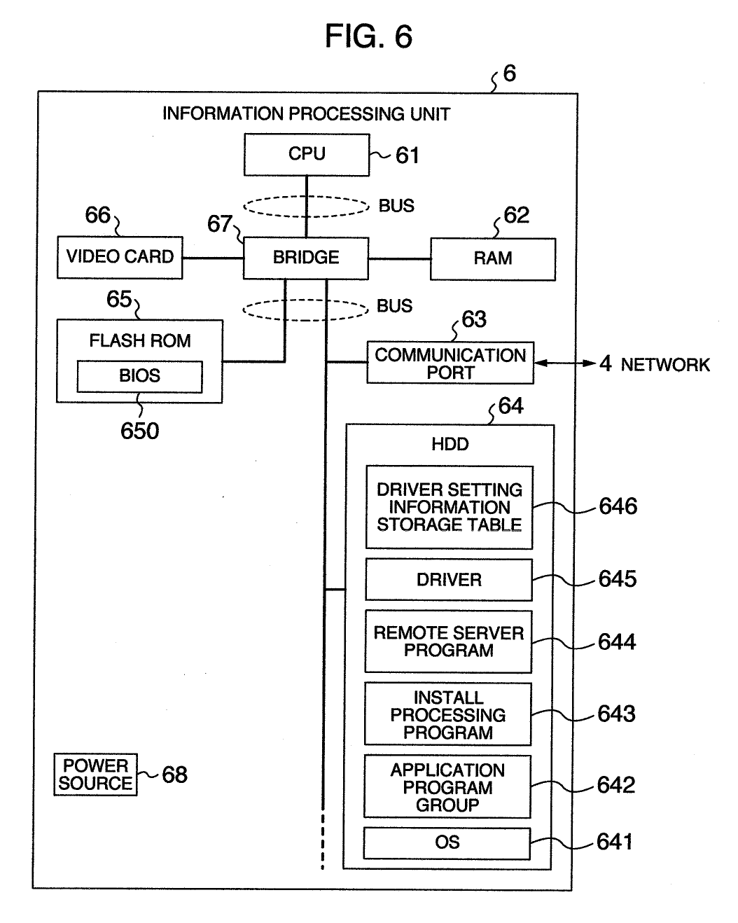

FIG. 6 shows a schematic structural example of the information processing unit 6.

As shown in the drawing, the information processing unit 6 includes a CPU 61, an RAM 62 that operates as a work area of the CPU 61, a communication port 63 for executing transmission and reception of information to and from a network, an HDD 64, a flash ROM 65, a video card 66 that creates video information of a desktop, a bridge 67 for relaying internal connection lines such as a bus BUS that connects each of these parts 61 to 66, and a power source 68.

The flash ROM 65 stores BIOS 650. After the power source 68 is turned on, the CPU 61 first gains access to the flash ROM 65, executes BIOS 650 and recognizes the system construction of the information processing unit 6.

The HDD 64 stores at least an application program group 642, an install processing program 643, a remote server program 644, a driver 645 and a driver setting information storage table 646. The driver 645 and driver setting information stored in the driver setting information storage table 646 are received from the management apparatus 5 and are stored in the HDD 64 by the install processing program 643.

The OS 641 is a program for the CPU 61 to collectively control each part 62 to 68 of the information processing unit 6 and to execute each program 642 to 645 to be later described. The CPU 61 loads the OS 614 from the HDD 64 to the RAM 62 and executes it in accordance with the BIOS 650. In consequence, the CPU 61 collectively controls each part 62 to 68 of the information processing unit 6.

The application program group 642 includes programs for a general purpose Web browser, a work processor, a spread sheet, and so forth. The CPU 61 loads a desired application program 642 from the HDD 64 to the RAM 62 and executes it in response to the instruction received from the terminal 1 through the remote server program 644. Video information of the desktop screen that reflects this execution result is created in the video card 66 and is transmitted to the terminal 1 through the remote server program 644.

The install processing program 643 executes the install processing of the driver received from the management apparatus 5 and stores the driver and driver setting information received into the HDD 64. The CPU 61 loads the install processing program 643 from the HDD 64 to the RAM 52 and executes this program in accordance with the OS 641.

The remote server program 644 is a program for providing the terminal service or in other words, for operating remotely the desktop of the information processing unit 6 from the terminal 1. The CPU 61 loads the remote server program 644 from the HDD 64 to the RAM 62 and executes this program in accordance with the OS 641. In consequence, the CPU 61 receives and processes the input information (operation content of keyboard and mouse) sent from the terminal 1 through the network 4 and the communication port 63 and transmits the video information (desktop screen of display) representing the processing result to the terminal 1 through the communication port 63 and the network 4.

When the peripheral device 3 is a printer, for example, the driver 645 first receives a printing instruction of the application from the terminal 1, then reads the driver setting information from the driver setting information storage table 646, generates printing data and transmits the printing data to the peripheral device 3 allocated to the information processing unit 6 through the communication port 63 and the network 4.

The explanation will be continued by turning back again to FIG. 1.

The terminal 1 receives the terminal service from the information processing unit 6. In other words, the terminal 1 transmits the input information (operation content of keyboard and mouse) inputted to the terminal 1 to the information processing unit 6, receives the video information (desktop screen of display) from the information processing unit 6 and displays the vide information on the display of the terminal 1.

By the way, the terminal 1 is a PC of a so-called “HDD-less type” and reduces the possibility of information leak owing to theft, or the like.

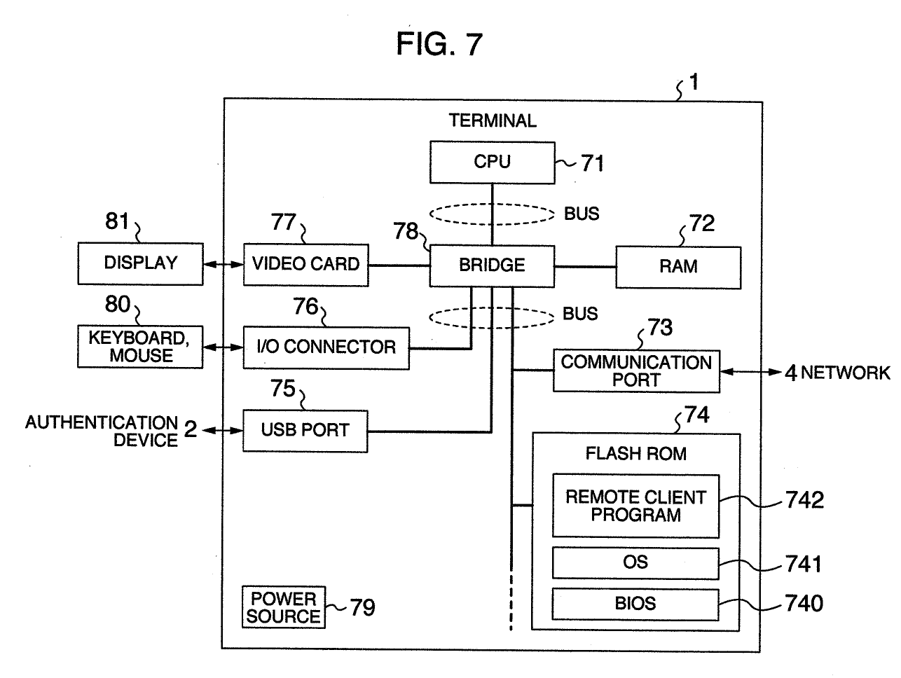

FIG. 7 shows a schematic structural example of the terminal 1.

As shown in the drawing, the terminal 1 includes a CPU 71, an RAM 72 that operates as a work area of the CPU 71, a communication port 73 for executing transmission and reception of information to and from a network 4, a flash ROM 74, a USB port 75 for connecting an authentication device 2, an I/O connector 76 for connecting a keyboard and a mouse 80, a video card 77 for connecting a display 81, a bridge 78 for relaying internal connection lines such as a bus BUS connecting each part 71 to 77 and a power source 79.

The flash ROM 74 stores at least a BIOS 740, an OS 741 and a remote client program 742.

After the CPU 71 is turned on, the CPU 71 gains access to the flash ROM 74, executes the BIOS 740 and recognizes the system construction of the terminal 1.

The OS 741 is a program for the CPU 71 to collectively control each part 72 to 79 of the terminal 1 and to execute a remote client program 742 to be later described. The CPU 71 loads the OS 741 from the flash ROM 74 to the RAM 72 and executes it in accordance with the BIOS 740. In consequence, the CPU 71 collectively controls each part 72 to 79 of the terminal 1. Incidentally, an OS that has a relatively small size and can be stored in the flash ROM 74 such as an embedded OS is used for the OS 741 in this embodiment.

The remote client program 742 is a program for receiving the terminal service or in other words, a program for the terminal 1 to gain access to the desktop of the information processing unit 6 from a remote place. The CPU 71 loads the remote client program 742 from the flash ROM 74 to the RAM 72 and executes this program in accordance with the OS 741. In consequence, the CPU 71 transmits the input information (operation content of keyboard and mouse) received through an I/O connector 76 to the information processing unit 6 through the communication port 73 and the network 4 and outputs the video information (desktop screen of display) sent from the information processing unit 6 through the network 4 to a display 81 connected to a video card 77.

The explanation will be continued by turning back again to FIG. 1.

An authentication device 2 authenticates terminal authentication information (user ID, password) received from the terminal 1 and reports the authentication result to the terminal 1. When the authentication result is established, the authentication device 2 reports information-processing-unit information (name of information processing unit and its address, etc) to the terminal 1. The authentication device 2 reads out remote authentication information and reports it to the terminal 1 in accordance with the instruction from the terminal for which authentication is established.

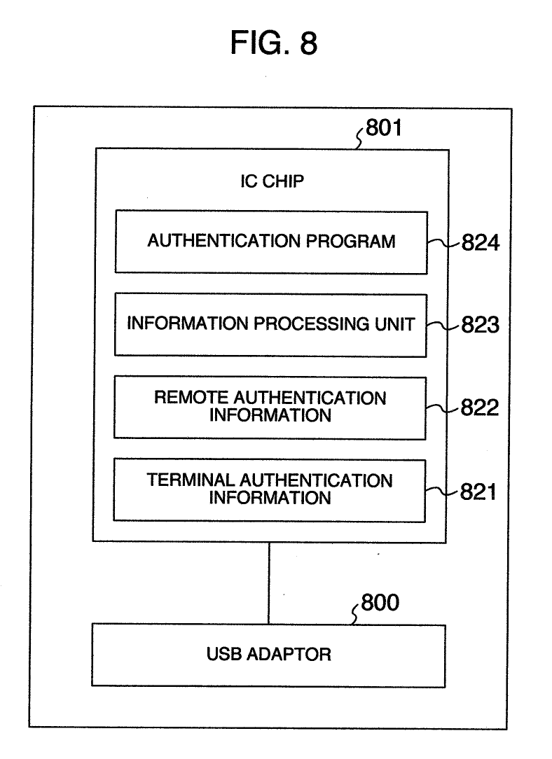

FIG. 8 is a schematic view of the authentication device 2. As shown in the drawing, the authentication device 2 has a USB adaptor 800 for the connection to a USB port 75 of the terminal 1 and an IC chip 801.

The IC chip 801 stores the terminal authentication information 821, the remote authentication information 822, the information-processing-unit information (name of information processing unit, its address, etc) and the authentication program 824. In this instance, it is possible to employ a construction in which a flash memory can be externally fitted to the authentication device 2 and a part of the data inside the IC chip 801 is stored in this flash memory.

The authentication program 824 is a program for executing user authentication by using the user ID and the password inputted to the terminal 1 to which the authentication device 2 is connected, and the terminal authentication information 821.

The USB adaptor 800 of the authentication device 2 is connected to the USB port 75 of the terminal 1. Consequently, when the power is supplied from the terminal 1 to the authentication device 2, the IC chip 801 executes the authentication program 824.

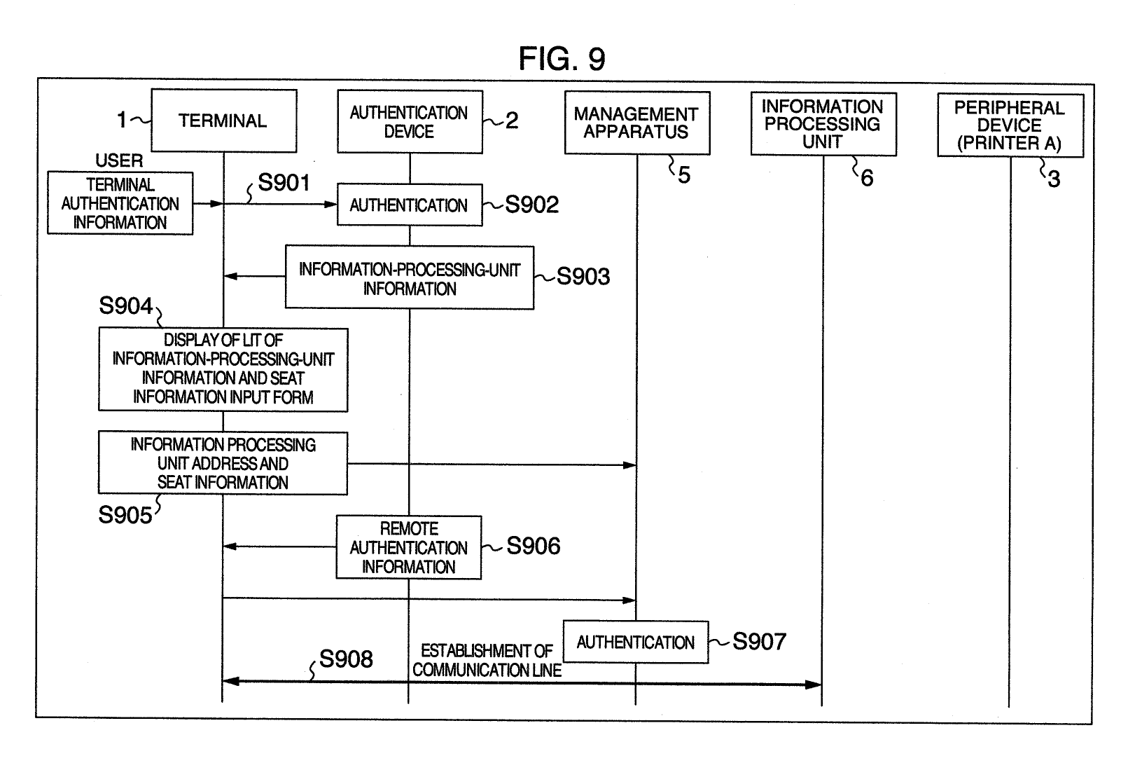

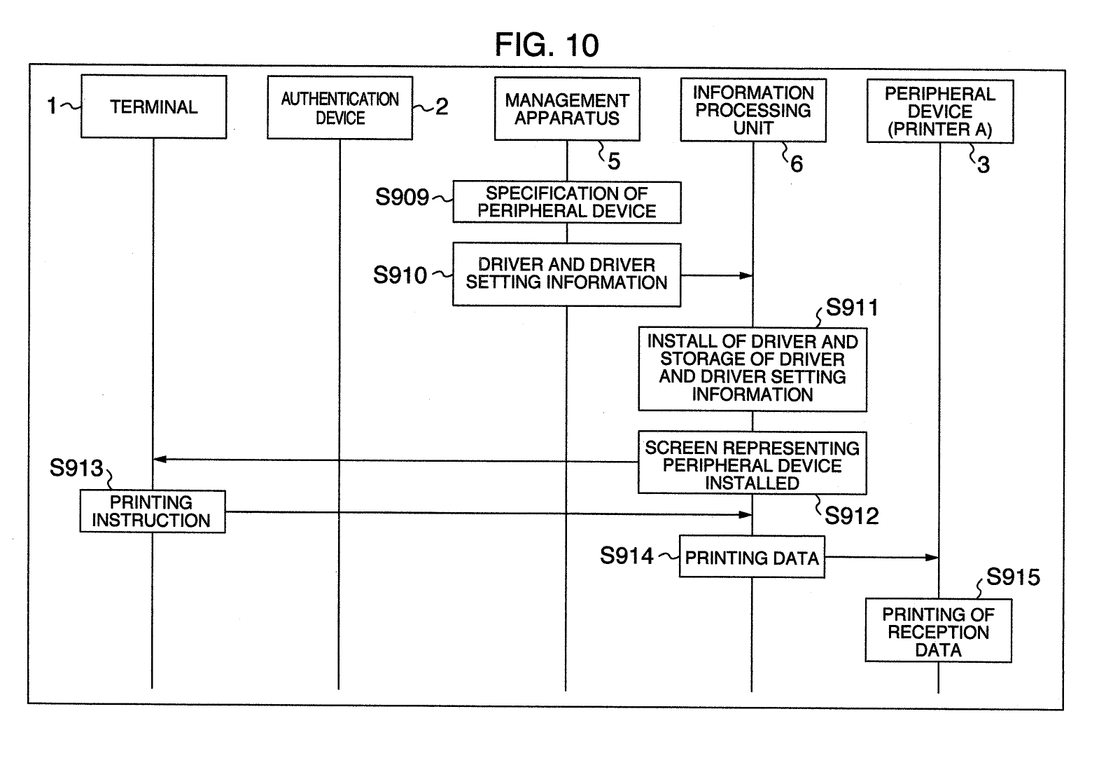

FIGS. 9 and 10 are views that are useful for explaining the operations of the entire information processing system according to this embodiment. Incidentally, each processing shown in the drawings is executed by the CPU in accordance with the program. To simplify the explanation, the explanation will be hereby given on each processing with the CPU being an execution subject. The peripheral device 3 is a printer, by way of example.

First, when the authentication device 2 is connected to the terminal 1, the CPU 71 of the terminal 1 lets the display 81 connected to the video card 77 display an input form of the terminal authentication information (user ID and password). The CPU 71 receives the terminal authentication information inputted from the keyboard and mouse 80 through the I/O connector 76, transmits it to the authentication device 2 connected to the USB port 75 and asks user authentication (S901).

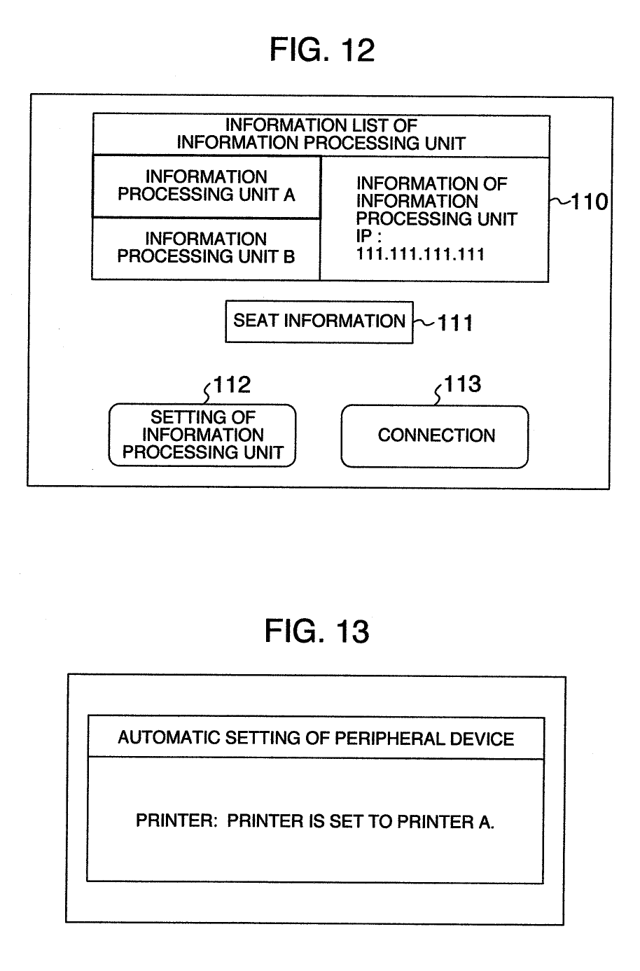

The authentication device 2 executes user authentication by using the terminal authentication information received from the terminal 1 and the terminal authentication information 821 (FIG. 8) registered in advance to the authentication device 2 (S902). When user authentication is established, the authentication device 2 transmits the information-processing-unit information (name of information processing unit, its address, etc) 823 (FIG. 8) registered in advance to the authentication device 2 to the terminal 1 (S903). When receiving this information, the CPU 71 of the terminal 1 displays a list of the information-processing-unit information (name of information processing unit, its address, etc) and the input form of the seat information that are shown in FIG. 12 (S904). In FIG. 12, the user selects the information processing unit and inputs the seat information (seat number: N−1, for example) into the seat information input column 111 by using the keyboard and mouse on the basis of paper seat information provision matter (FIG. 11) provided to the own seat of the user. When the user clicks connection 113 by using the mouse 80, the seat information (for example, N−1) received through the address of the information processing unit (IP address: 111, 111, 111, 111, for example) and the I/O connector 76 is transmitted to the management apparatus 5 through the communication port 73 and the network 4 (S905).

The CPU 71 of the terminal 1 receives the remote authentication information 822 (FIG. 8) registered in advance into the authentication device 2 from the authentication device 2 through the USB port 75 and transmits this information 822 to the management apparatus 5 through the communication port 73 and the network 4 (S906).

When receiving the remote authentication information 822 described above through the communication port 23, the CPU 21 of the management apparatus 5 collates the remote authentication information 822 with the remote authentication information registered in advance to the authentication information management table 244 and executes user authentication (S907). When the user authentication is established, a communication path is established between the terminal 1 and the information processing unit 6 having the address (IP address: 111, 111, 111, 111, for example) of the information processing unit received from the terminal 1 by a predetermined program (not shown) provided to the terminal 1 and to the information processing unit 6 (S908). Incidentally, when the authentication result by the authentication device 2 is not established in S902, the CPU 71 of the terminal 1 receiving this report executes a predetermined error processing by displaying an error message on the display screen, for example.

Next, the CPU 21 of the management apparatus 5 retrieves the peripheral device allocation table 245 (FIG. 4) on the basis of the seat information received in S905 and judges whether or not the seat information coincident with the seat information received exists. When the coincident seat information exists, the CPU 21 retrieves the driver and driver setting information management table 246 (FIG. 5) on the basis of the peripheral device name 402 registered to the record 403, reads out the driver setting information 502 and the driver 503 and transmits these kinds of information to the information processing unit 6 through the communication port 23 and the network 4 (S909 and S910). In other words, the CPU 21 specifies the peripheral device suitable for the utilization site of the terminal 1 from among a plurality of peripheral devices and transmits the driver 503 of the peripheral device so specified and its driver setting information 502 to the information processing unit 6 through the communication port 23 and the network 4 on the basis of the address of the information processing unit received in S905. Incidentally, when the information coincident with the seat information received does not exist in the peripheral device allocation table 245 in S909, the CPU 21 transmits a message such as “No usable peripheral device exists” to the terminal 1 through the communication pot 23 and the network 4.

The CPU 61 of the information processing unit 6 executes an install processing of the driver received and stores the driver setting information 502 and driver 503 received into the HDD 64 (driver setting information storage table 646, driver 645) (S911). Next, the CPU 61 generates a screen (FIG. 13) for reporting the allocated peripheral device to the user and transmits it to the terminal 1 through the communication port 63 and the network 4 (S912).

Next, when receiving the printing instruction of the application under operation from the terminal 1 through the network 4 and the communication port 63 (S913), the CPU 61 of the information processing unit 6 reads the driver setting information from the driver setting information storage table 646, generates the printing data and transmits this data to the corresponding printer A through the network 4 (S914). The printer A has a hardware construction similar to that of general purpose printers and prints the printing data from the information processing unit 6 (S915).

The above explains the first embodiment of the invention.

The first embodiment described above can provide the technology of automatically allocating the peripheral device suitable for the utilization site to the terminal and automatically executing installation of the driver of the peripheral device allocated and automatically setting the driver setting information. Consequently, the user can use the peripheral device suitable for the utilization site of the terminal without the necessity for manually installing the driver and setting the driver setting information. In other words, the trouble and the time that have been necessary in the past for installing the driver and setting the driver setting information can be saved.

Since the first embodiment described above allocates a peripheral device suitable for a utilization site of each terminal, the access does not concentrate on a specific peripheral device and the load to the peripheral device can be dispersed.

### Second Embodiment

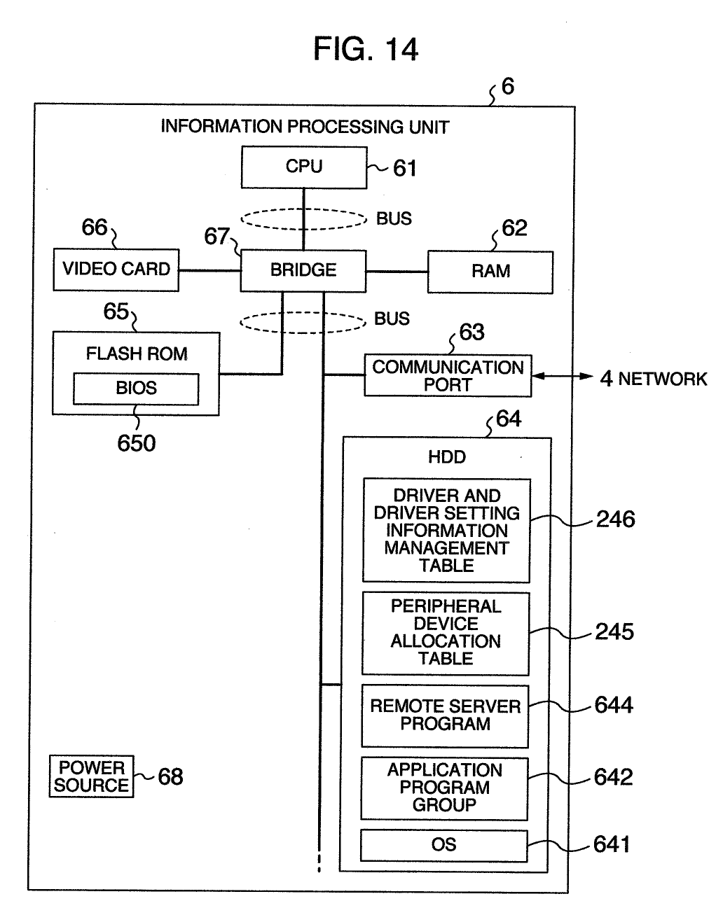

In the second embodiment, the information processing unit 6 includes a peripheral device allocation table 245 and a driver and driver setting information management table 246 as shown in FIG. 14 and the remote serve program 644 has a function of the peripheral device allocation program 243 (FIG. 2). The construction of each of the peripheral device allocation table 245 and the driver and driver setting information management table 246 is similar to the construction shown in FIGS. 4 and 5.

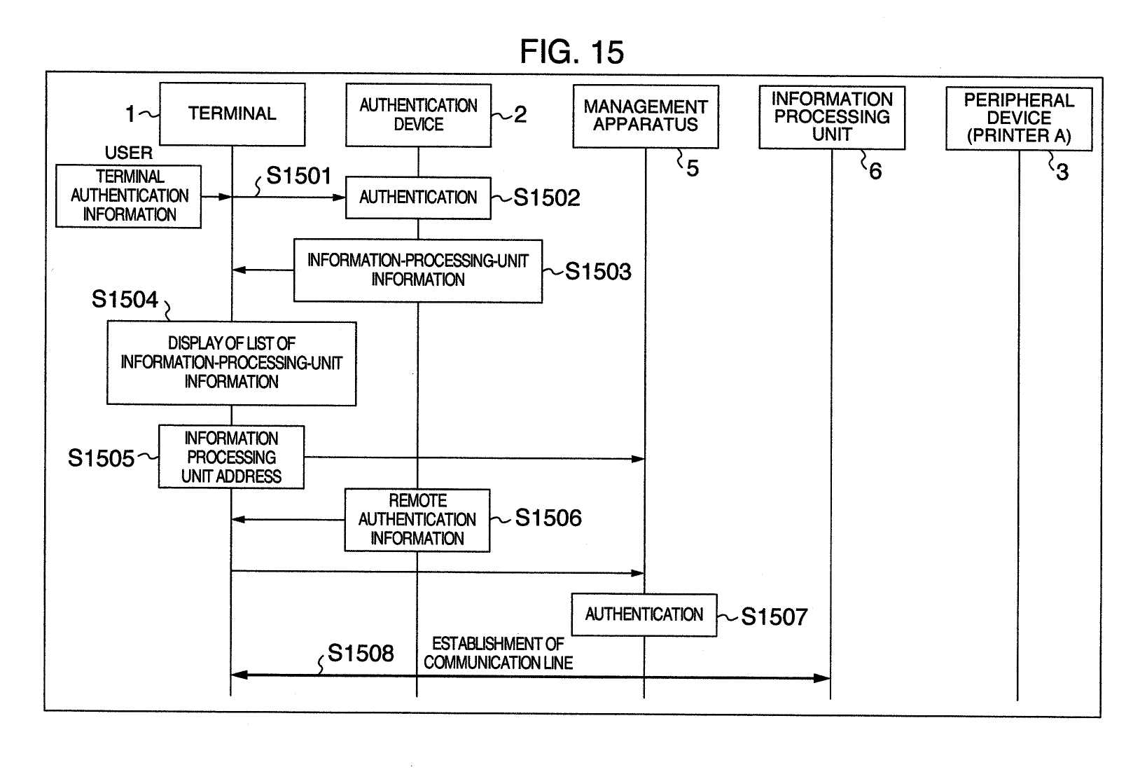

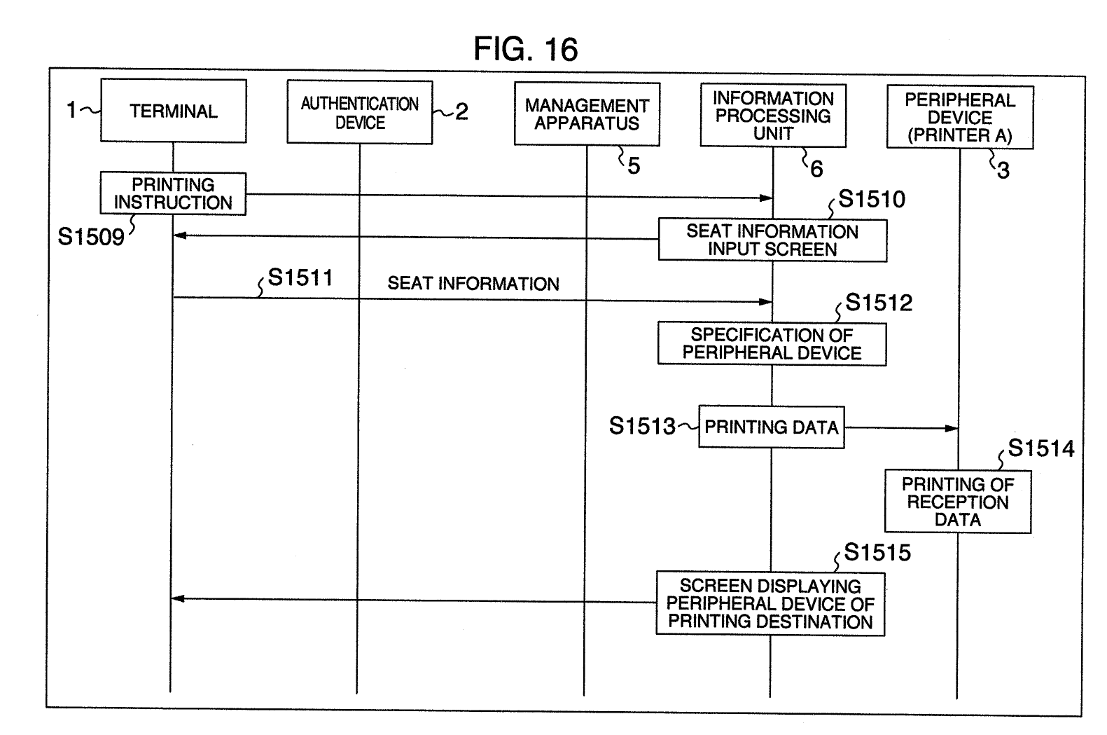

FIGS. 15 and 16 are views that are useful for explaining the operations of the entire information processing system according to the second embodiment.

First, when the authentication device 2 is connected to the terminal 1, the CPU 71 of the terminal 1 lets the display connected to the video card 77 display the input form of the terminal authentication information (user ID and password). The CPU 71 accepts the terminal authentication information inputted from the keyboard and mouse 80 through the I/O connector 76, transmits it to the authentication device 2 connected to the USB port 75 and asks user authentication (S1501).

The authentication device 2 executes user authentication by using the terminal authentication information received from the terminal 1 and the terminal authentication information 821 (FIG. 8) registered in advance to the authentication device 2 (S1502). When user authentication is established, the authentication device 2 transmits the information-processing-unit information (name of information processing unit, its address, etc) 823 (FIG. 8) registered in advance to the authentication device 2 to the terminal 1 (S1503). When receiving this information, the CPU 71 of the terminal 1 displays a list of the information-processing-unit information (name of information processing unit, its address, etc) (S1504). When the user selects the information processing unit from the information list screen of the information processing unit and clicks the connection 113 by the mouse, the address of the information processing unit (IP address: 111, 111, 111, 111, for example) is transmitted to the management apparatus 5 through the communication port 73 and the network 4 (S1505).

The CPU 71 of the terminal 1 receives the remote authentication information 822 (FIG. 8) registered in advance into the authentication device 2 from the authentication device 2 through the USB port 75 and transmits this information 822 to the management apparatus 5 through the communication port 73 and the network 4 (S1506).

When receiving the remote authentication information 822 described above through the communication port 23, the CPU 21 of the management apparatus 5 collates the remote authentication information 822 with the remote authentication information registered in advance to the authentication information management table 244 and executes user authentication (S1507). When the user authentication is established, a communication path is established between the terminal 1 and the information processing unit 6 having the address (IP address: 111, 111, 111, 111, for example) of the information processing unit received from the terminal 1 by a predetermined program (not shown) provided to the terminal 1 and to the information processing unit 6 (S1508).

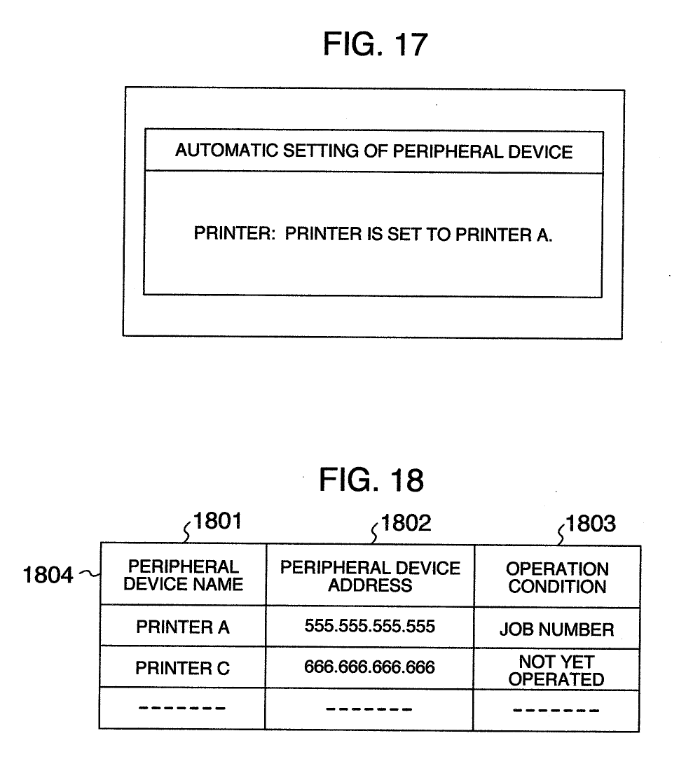

Next, when receiving the printing instruction of the application 642 under operation through the communication port 63 (S1509), the CPU 61 of the information processing unit 6 generates the input screen of the seat information and transmits this data to the terminal 1 through the communication port 63 and the network 4 (S1511). Next, when receiving the seat information from the terminal 1 (S1511), the CPU 61 specifies the peripheral device suitable for the utilization site of the terminal 1 on the basis of the seat information received and the information of the peripheral device allocation table 245 (S1512). The CPU 61 then retrieves the driver and driver setting information management able 246 on the basis of the peripheral device name 402 registered to the record 403 of the peripheral device allocation table 245. The CPU 61 generates the printing data on the basis of the driver setting information 502 read out from the record 504, the driver 503 and the application to which the printing instruction is given and transmits the printing data to the corresponding printer A through the network 4 (S1513). The printer A has a construction similar to that of general purpose printers and prints the printing data from the information processing unit 6 (S1514). The information processing unit 6 generates a screen (FIG. 17) for reporting the printer as the peripheral device to the user and transmits the screen to the terminal 1 through the communication port 63 and the network 4 (SI515).

### Third Embodiment

An embodiment wherein a plurality of usable peripheral devices exists for one group will be explained. The HDD 24 of the management apparatus 5 shown in FIG. 2 further includes in this case a peripheral device condition management table 247. FIG. 18 shows a structural example of the peripheral device condition management table 247. As shown in the drawing, a record 1804 of the peripheral device condition management table 247 has a field 1801 for registering the name of the peripheral device, an address 1802 of the peripheral device and a field 1803 for registering an operation condition of the peripheral device. A plurality of peripheral device names is registered for one seat information to the record 403 of the peripheral device allocation table 245. The CPU 21 of the management apparatus 5 monitors each peripheral device through the network 4. The CPU 21 receives the operation condition data for detecting the operation condition from each peripheral device, registers the operation condition of the peripheral device condition management table 247 on the basis of this data and executes updating.

Those operational portions which are different from the operations of the entire information processing system of the first embodiment shown in FIGS. 9 and 10 will be hereinafter explained with reference to these drawings.

### <S909 and S910>

The CPU 21 of the management apparatus 5 retrieves the peripheral device allocation table 245 on the basis of the seat information received in S905 and judges whether or not seat information coincident with the seat information received exists is judged. When the coincident seat information exists, the CPU 21 decides the usable peripheral device on the basis of the peripheral device name registered to the record 403 and the information of the peripheral device management table 247 (FIG. 18). The CPU 21 then retrieves the driver and driver setting information table 246 (FIG. 5) on the basis of the peripheral device name so decided, reads out the peripheral device name 501, the driver setting information 502 and the driver 503 from the record 504 and transmits these kinds of information to the information processing unit 6 through the communication port 23 and the network 4.

### Fourth Embodiment

An embodiment wherein the seat information is QR (Quick Response Code) or RFID (Radio Frequency Identification) tag information will be explained. The information processing system in this case has an information reader for reading information such as the QR code and the RFID tag information in addition to the system construction shown in FIG. 1. In this embodiment, the seat information read by the information reader is sent to the terminal 1 and is reflected on the seat information input column 111 shown in FIG. 12. The address of the communication equipment 6 and the seat information are transmitted to the management apparatus 5. The rest of the operations are analogous to those of the first embodiment shown in FIGS. 9 and 10. Incidentally, the information reader may be a mobile terminal as long as it is equipped with means for reading the QR code or the RFID tag information.

### Fifth Embodiment

The first to fourth embodiments given above have been explained about the case where the management apparatus 5 has the peripheral device allocation table 245 storing the seat information in association with the peripheral device name. However, the seat information may be stored in the driver and driver setting information management table 246 shown in FIG. 5. In this case, the management apparatus 5 can specify the peripheral device from the seat information received and the information of the driver and driver setting information management table 246.

### Sixth Embodiment

The first to fifth embodiments given above have been explained about the case where the peripheral device is specified on the basis of the seat information. However, the peripheral device may be specified on the basis of the group identification information. The same peripheral device is used in the group unit such as a department or a section and the leak of information can be reduced because the output content is not outputted to the peripheral devices of other departments and sections.

### Other Embodiments

The first embodiment given above has been explained about the case where the peripheral device is specified on the basis of the seat information. However, the peripheral device may be specified on the basis of position information acquired by a wireless LAN position detector installed at the utilization site by using the wireless LAN (Local Area Network). In this case, the terminal 1 shown in FIG. 7 further has a wireless LAN communication portion that communicates with the wireless LAN position detector. The management apparatus 5 shown in FIG. 2 further has a position information reception portion for receiving the signal that the wireless LAN position detector receives from the terminal 1 and a position calculation portion for calculating position information representing the position of the terminal 1 on the basis of the reception signal.

The first embodiment given above has been explained about the case where the peripheral device is specified on the basis of the seat information. However, the peripheral device may be specified on the basis of a fixed IP address by allocating the fixed IP address to each seat.

The first embodiment given above has been explained about the case where the peripheral device is specified on the basis of the seat information. However, it is also possible to keep the terminal 1 fixed at the seat and to specify the peripheral device on the basis of an MAC address of the terminal 1.

Use history information of the peripheral devices of the users may be managed by the management apparatus 5 and by so doing, illegal takeout of the output matter can be suppressed and counter-measure against accidental information leak can be taken at an early stage.

The first to six embodiments given above have been explained about the case where the invention is applied to the terminals 1 of the remote desktop system as a so-called “thin client type” information processing system but the invention can be applied to ordinary PCs, too.

It should be further understood by those skilled in the art that although the foregoing description has been made on embodiments of the invention, the invention is not limited thereto and various changes and modifications may be made without departing from the spirit of the invention and the scope of the appended claims.

1. A method for allocating peripheral devices in an information processing system including a management apparatus, a plurality of terminals, a plurality of information processing units and a plurality of peripheral devices that are connected to one another through a network, wherein:
said terminal transmits address information of an information processing unit as a communication counter-part and information relating to a utilization site of said terminal to said management apparatus through said network;
said management apparatus receives from said terminal the address information of said information processing unit and the information relating to the utilization site of said terminal through said network, specifies any of said peripheral devices from among said plurality of peripheral devices on the basis of information of storage means storing the information relating to the utilization site of said terminal received and the information relating to the utilization sites of said plurality of terminals in association with one another and the driver and driver setting information of said plurality of peripheral devices, reads out the driver and driver setting information of said peripheral device specified from said storage means and transmits the driver and driver setting information to said information processing unit through said network on the basis of said address information; and
said information processing unit receives the driver and driver setting information of said peripheral device from said management apparatus through said network and executes installation of said driver received and setting of the driver setting information.

2. A method for allocating peripheral devices according to claim 1, wherein said management apparatus manages condition information of said plurality of peripheral devices, receives, through said network, the address information of said information processing unit and the information relating to the utilization site of said terminal received, specifies any of said peripheral devices from among said plurality of peripheral devices on the basis of information of storage means storing the information relating to the utilization site of said terminal received, the condition information of said plurality of peripheral devices, the information relating to the utilization sites of said plurality of terminals and the driver and driver setting information of said plurality of peripheral devices in association with one another, reads out the driver and driver setting information of said peripheral device specified from said storage means, and transmits the driver and driver setting information to said information processing unit through said network on the basis of said address information.

3. A method for allocating peripheral devices according to claim 2, wherein said information processing unit generates a screen for reporting said peripheral device specified to a user of said information transmitting terminal and transmits said screen to said information transmitting terminal through said network.

4. A method for allocating peripheral devices according to claim 3, wherein said terminal gives an output instruction of an application to said information processing unit through said network; and
said information processing unit generates output data to said peripheral device on the basis of the driver and driver setting information of said peripheral device specified and said application when the output instruction of said application is received from said terminal, and transmits the output data to said peripheral device through said network.

5. An information processing system including a management apparatus, a plurality of terminals, a plurality of information processing units and a plurality of peripheral devices that are connected to one another through a network, wherein:
said terminal has means for transmitting address information of an information processing unit as a communication counter-part and information relating to a utilization site of said terminal to said management apparatus through said network;
said management apparatus includes means for storing information relating to utilization sites of said plurality of terminals and driver and driver setting information of said plurality of peripheral devices in association with one another, means for receiving the address information of said information processing unit and the information relating to the utilization site of said terminal from said terminal through said network, means for specifying any of said peripheral devices from among said plurality of peripheral devices on the basis of the information relating to the utilization site of said terminal received by said reception means and the information of said storage means, and means for reading out the driver and driver setting information of said peripheral device specified from said storage means and transmitting the driver and driver setting information to said information processing unit through said network on the basis of said address information; and
said information processing unit includes means for receiving the driver and driver setting information of said peripheral device from said management apparatus through said network and means for executing installation of said driver received and setting of the driver setting information.

6. An information processing system according to claim 5, wherein said management means includes means for storing information relating to the utilization sites of said plurality of terminals and the driver and driver setting information of said plurality of peripheral devices in association with one another, mean for managing condition information of said plurality of peripheral devices, means for receiving the address information of said information processing unit and the information relating to the utilization site of said terminal from said terminal through said network, means for specifying any of said peripheral devices from among said plurality of peripheral devices on the basis of the information relating to the utilization site of said terminal received by said reception means, the information of said storage means and the condition information of said plurality of peripheral devices, and means for reading out the driver and driver setting information of said peripheral device specified from said storage means and means for transmitting the driver and driver setting information to said information processing unit through said network on the basis of said address information.

7. An information processing system according to claim 6, wherein said information processing unit further includes means for generating a screen for reporting said peripheral device specified to a user of said information transmitting terminal and transmitting said screen to said information transmitting terminal through said network.

8. An information processing system according to claim 7, wherein said terminal further includes means for giving an output instruction of an application to said information processing unit through said network; and
said information processing unit further includes means for generating output data to said peripheral device on the basis of the driver and driver setting information of said peripheral device specified and said application when the output instruction of said application is received from said terminal, and transmitting the output data to said peripheral device through said network.

9. A management apparatus connected to a plurality of terminals, a plurality of information processing units and a plurality of peripheral devices through a network, comprising:
a storage portion for storing information relating to utilization sites of said plurality of terminals and driver and driver setting information of said plurality of peripheral devices in association with one another;
a reception portion for receiving address information of said information processing unit and the information relating to the utilization sites of said terminals from said terminal through said network; and
a control portion for specifying any of said peripheral devices from said plurality of peripheral devices on the basis of the information relating to the utilization sites of said terminals received by said reception portion and the information of said storage portion, reading out said driver and driver setting information of said peripheral device specified and transmitting them to said information processing unit through said network on the basis of said address information.

10. A management apparatus connected to a plurality of terminals, a plurality of information processing units and a plurality of peripheral devices through a network, comprising:
a first storage portion for storing information relating to utilization sites of said plurality of terminals and driver and driver setting information of said plurality of peripheral devices in association with one another;
a second storage portion for storing condition information of said plurality of peripheral devices;
a reception portion for receiving address information of said information processing unit and the information relating to the utilization sites of said terminals from said terminal through said network; and
a control portion for specifying any of said peripheral devices from said plurality of peripheral devices on the basis of the information relating to the utilization site of said terminal received by said reception portion and the information of said first and second storage portions, reading out the driver and driver setting information of said peripheral device specified from said first storage portion and transmitting them to said information processing unit through said network on the basis of said address information.

11. A peripheral device allocation method to be executed by an information processing unit connected to at least a plurality terminals and a plurality of peripheral devices through a network, said method executing:
a processing for generating a screen for inputting information relating to a utilization site of said terminal when an output instruction of an application is received from said terminal, and transmitting said screen to said terminal; and
a processing for specifying any of said peripheral devices from said plurality of peripheral devices on the basis of the information relating to the utilization site of said terminal received and the information of storage means storing the information relating to the utilization sites of said plurality of terminals and the driver and driver setting information of said plurality of peripheral devices in association with one another when the information relating to the utilization site of said terminal is received from said terminal, generating said output data on the basis of the driver of said peripheral device, the driver setting information and said application and transmitting them to said peripheral device through said network.

12. A peripheral device allocation method to be executed by an information processing unit connected to at least a plurality terminals and a plurality of peripheral devices through a network, said method executing:
a processing for generating a screen for inputting information relating to a utilization site of said terminal when an output instruction of an application is received from said terminal, and transmitting said screen to said terminal; and
a processing for specifying any of said peripheral devices from said plurality of peripheral devices on the basis of the information relating to the utilization site of said terminal received when the information relating to the utilization site of said terminal is received from said terminal and the information of storage means for storing the information relating to the utilization sites of said plurality of terminals, the driver and driver setting information of said plurality of peripheral devices in association with one another and the condition information of said plurality of peripheral devices managed by said information processing unit, generating output data on the basis of the driver and driver setting information of said peripheral device and said application, and transmitting them to said peripheral device through said network.

13. A peripheral device allocation method according to claim 11, which further executes a processing for generating a screen to report said peripheral device as an output destination of said output data to a user of said information transmitting terminal, and transmitting said screen to said information transmitting terminal through said network.

14. A peripheral device allocation method according to claim 12, which further executes a processing for generating a screen to report said peripheral device as an output destination of said output data to a user of said information transmitting terminal, and transmitting the screen to said information transmitting terminal through said network.

15. An information processing unit connected to at least a plurality terminals and a plurality of peripheral devices through a network, comprising:
a storage portion for storing information relating to utilization sites of said plurality of terminals and drivers and driver information of said plurality of peripheral devices in association with one another; and
a control portion for generating a screen for inputting information relating to a utilization site of said terminal when an output instruction of an application is received from said terminal, transmitting said screen to said terminal, and specifying any of said peripheral devices from said plurality of peripheral devices on the basis of the information relating to the utilization site of said terminal received and the information of said storage portion when the information relating to the utilization site of said terminal is received from said terminal, generating output data on the basis of the driver and driver setting information of said peripheral device and said application, and transmitting them to said peripheral device through said network.

16. An information processing unit connected to at least a plurality terminals and a plurality of peripheral devices through a network, comprising:
a first storage portion for storing information relating to utilization sites of said plurality of terminals and drivers and driver information of said plurality of peripheral devices in association with one another;
a second storage portion for storing condition information of said plurality of peripheral devices; and
a control portion for generating a screen for inputting information relating to a utilization site of said terminal when an output instruction of an application is received from said terminal, transmitting said screen to said terminal, and specifying any of said peripheral devices from said plurality of peripheral devices on the basis of the information relating to the utilization site of said terminal received and the information of said first and second storage portions when the information relating to the utilization site of said terminal is received from said terminal, generating said output data on the basis of the driver and driver setting information of said peripheral device and said application and transmitting them to said peripheral device through said network.

17. An information processing unit according to claim 15, which further comprises means for generating a screen for reporting a peripheral device as an output destination of said output data to a user of said information transmitting terminal and transmitting said screen to said information transmitting terminal through said network.

18. An information processing unit according to claim 16, which further comprises means for generating a screen for reporting a peripheral device as an output destination of said output data to a user of said information transmitting terminal and transmitting said screen to said information transmitting terminal through said network.

19. A method for allocating peripheral devices in an information processing system comprising the steps of:
transmitting, at one of a plurality of terminals, address information of an information processing unit as a communication counter-part and information relating to a utilization site of the one of terminals to a management apparatus connected to each of the terminals through a network;
receiving, at the management apparatus, the address information of the information processing unit and the information relating to the utilization site of the terminal;
specifying, at the management apparatus, any of peripheral devices from among a plurality of peripheral devices on the basis of information of storage within the management apparatus for storing the information relating to the utilization site of the terminal received and the information relating to the utilization sites of the plurality of terminals in association with one another and the driver and driver setting information of the plurality of peripheral devices;
reading out a driver and driver setting information of the peripheral device specified from the storage;
transmitting, at the management apparatus, the driver and driver setting information to the information processing unit through the network on the basis of the address information; and
receiving, at an information processing unit connected to the plurality of terminals and management apparatus through the network, the driver and driver setting information of the peripheral device from the management apparatus and executing installation of the driver received and setting of the driver setting information.
